(19) United States
(12) Patent Application Publication
(10) Pub. No.: US 2018/0036982 A1
(43) Pub. Date: Feb. 8, 2018

(54) POWDER PRESS AND A FEED HOUSING HAVING PREFERABLY A PLURALITY OF STAMPS WHICH ARE MOVABLE FOR A TRANSVERSE PRESS

(71) Applicant: Dietmar W Kramer, Auslikon (CH)

(72) Inventor: Dietmar W Kramer, Auslikon (CH)

(21) Appl. No.: 15/555,138

(22) PCT Filed: Feb. 26, 2016
(86) PCT No.: PCT/EP2016/054121

§ 371 Date: Sep. 1, 2017

(30) Foreign Application Priority Data
Mar. 5, 2015 (CH) 312/15

(51) Int. Cl. B30B 11/00; B30B 15/00; B22F 3/03; B30B 15/06

(52) U.S. Cl. CPC B30B 11/007; B30B 11/004; B30B 15/065; B30B 15/007; B22F 3/03

(57) ABSTRACT

The invention relates to a powder press having preferably a plurality of stamps (11) which are movable for a transverse press in a feed housing (10), said stamps partially delimiting a hollow chamber of a matrix in the feed housing (10) and being able to be coupled to a press device (40) by one connector piece each. An adjustable positioning means, which is formed from a wedge arrangement (20) having a stop surface (22) and placed crosswise to the moving direction of the stamp (11) is allocated to the respective stamp (11) for determining the pressing position thereof. Said wedge arrangement (20) comprises at least one wedge (21), which is adjustable crosswise to the moving direction of the stamp (11) and has the stop surface (22), which contacts a stop surface (11″) at the stamp (11). Such a wedge arrangement can achieve very accurate pressing positions of the stamp, first of all, and extremely stable positioning of the stamp to be pressed with high pressure, second of all.

The invention relates to a powder press according to the preamble to claim 1 and to a feed housing according to the preamble to claim 8.

A powder press for the production of a pressed article according to publication EP-A-2 103 423 is provided with an upper and a lower stamp arrangement as well as a matrix arrangement which forms a mould cavity into which the powdered metal can be poured. Next, in order to mould the pressed article the stamp arrangements are pressed against one another in the direction of pressing. Moreover, transverse press devices are provided which are each connected to a transverse press stamp which can be pushed substantially crosswise into a pressing position through an opening in the matrix by means of a drive. The drive of each transverse press device is connected to a first wedge, the wedge surface of which acts on the surface of a second wedge which can be moved substantially at a right angle to the first wedge in the transverse pressing direction. In addition, an adjustable stop is provided as positioning means for determining the pressing position of a respective transverse pressing stamp. The latter is formed by a third wedge that can be adjusted crosswise to the moving direction of the first wedge. The first wedge strikes this third wedge as soon as the pressing position of the transverse press stamp is reached. It is a disadvantage here that this type of stop is not sufficiently stable with high pressing forces, and this position of the stamp may change inadvertently.

In contrast, it is the object of the present invention to improve a press device, in particular for the transverse pressing of a powder press, such that it guarantees very stable positioning of the transverse press stamp, even with very high pressing forces, and the pressing position of this transverse press stamp can additionally be adjusted easily and very accurately.

According to the invention, this object is achieved by the features of claim 1 and of claim 8.

The powder press according to the invention makes provision such that the positioning means are respectively formed from a wedge arrangement having a stop surface and placed crosswise to the moving direction of the stamp, this stop surface serving directly as a stop for the stamp or as a stop for the extension piece coupled to the latter.

With this type of wedge arrangement one can on the one hand achieve very accurate pressing positions of these stamps, and on the other hand this arrangement enables exceptionally stable positioning of the stamps that are to be pressed with high pressures.

Advantageously, the wedge arrangements are formed with wedge surfaces which have an angle of a few angular degrees in relation to their longitudinal extension so that this wedge arrangement is in the self-inhibiting range. This enables the stops to permanently remain securely in position as desired for these stamp positionings which are to be implemented numerous times.

With the feed housing according to the invention a positioning means is assigned to each stamp, which means is respectively stored in the feed housing and is formed from a wedge arrangement having a stop surface placed crosswise to the moving direction of the stamp.

The feed housing with the stamps and the wedge arrangements can thus be produced as one unit, by means of which the desired accurate pressing positions can be achieved optimally by simple handling.

Exemplary embodiments of the invention and further advantages are explained in more detail below by means of drawings. These show as follows:

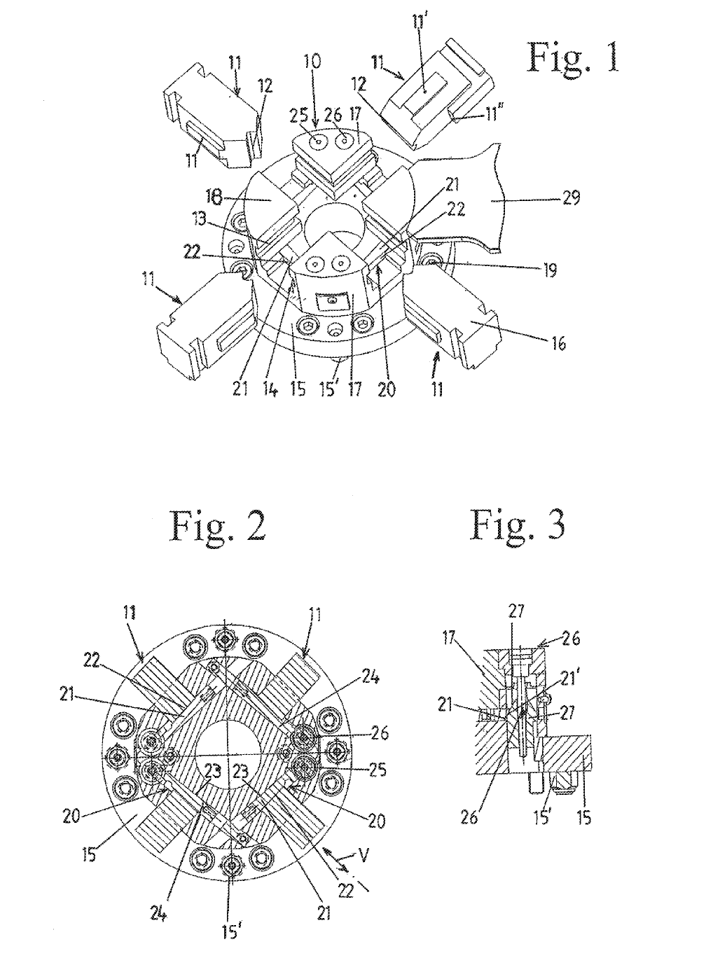

FIG. 1 is a perspective view of a feed housing of a powder press according to the invention, wherein the press stamps are shown in exploded form, one being shown rotated about 90° in order to give a better illustration;

FIG. 2 is a section through the feed housing according to claim 1 with an illustration of wedge arrangements;

FIG. 3 is a vertical partial section through an adjusting means in the feed housing according to FIG. 2;

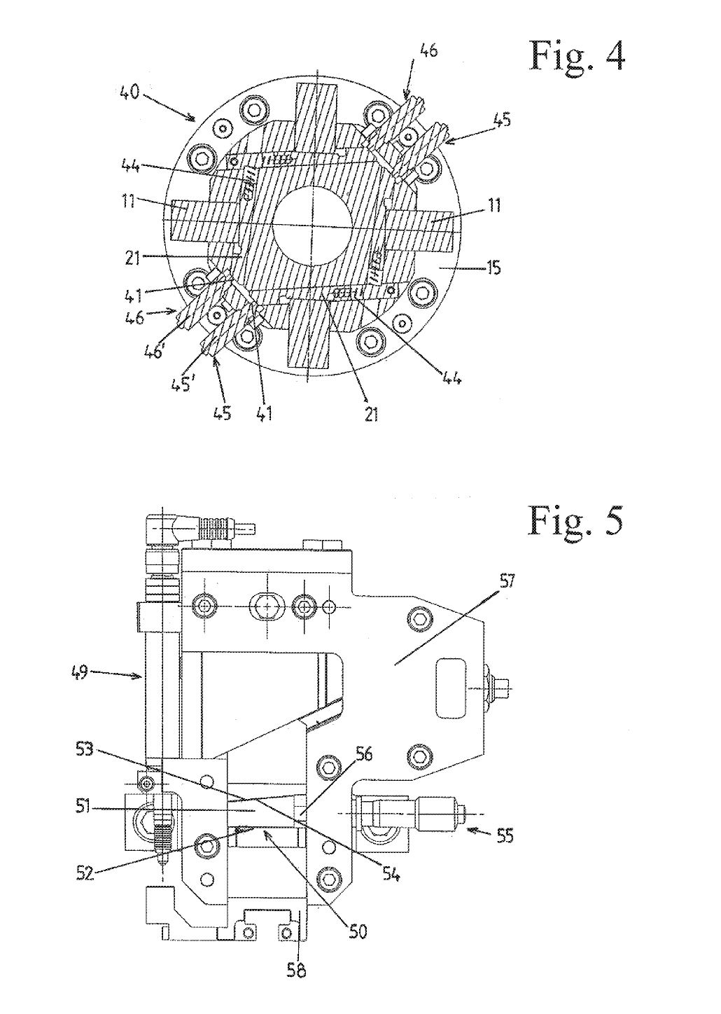

FIG. 4 is a section through a feed housing according to the invention, wherein, as a variant, the stamps and the adjusting means are arranged more or less radially;

FIG. 5 is a top view of a press device of a powder press according to the invention, wherein the wedge arrangement is provided with the stamp on the connector piece;

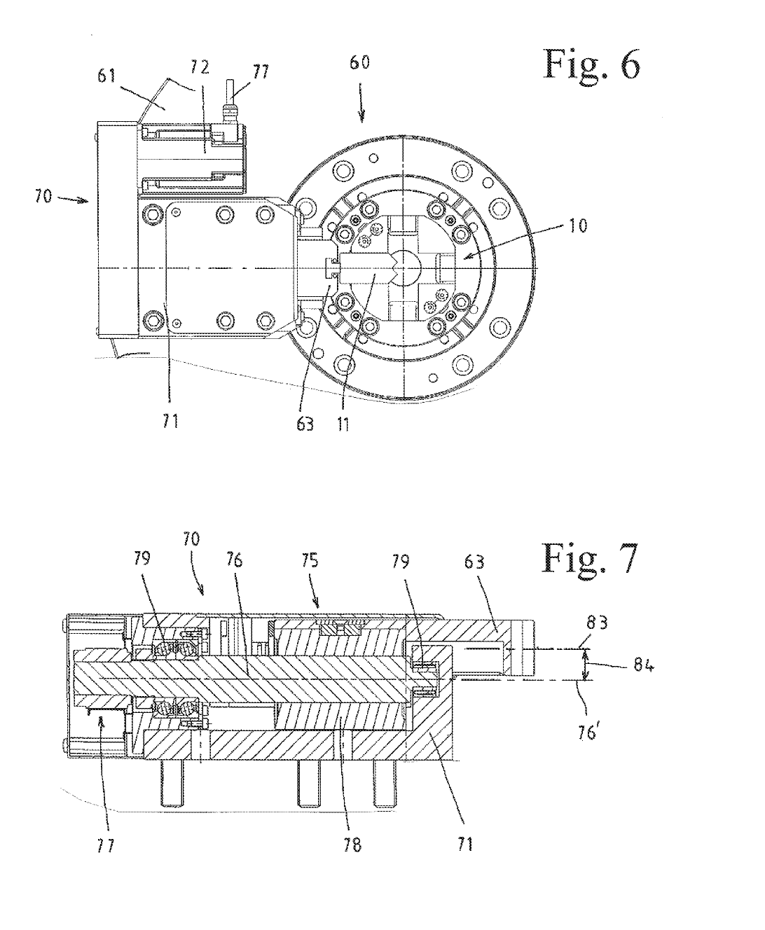

FIG. 6 is a top view of a powder press with a feed housing according to the invention and one of the four press devices to be used;

FIG. 7 is a section through the press device according to FIG. 6, and

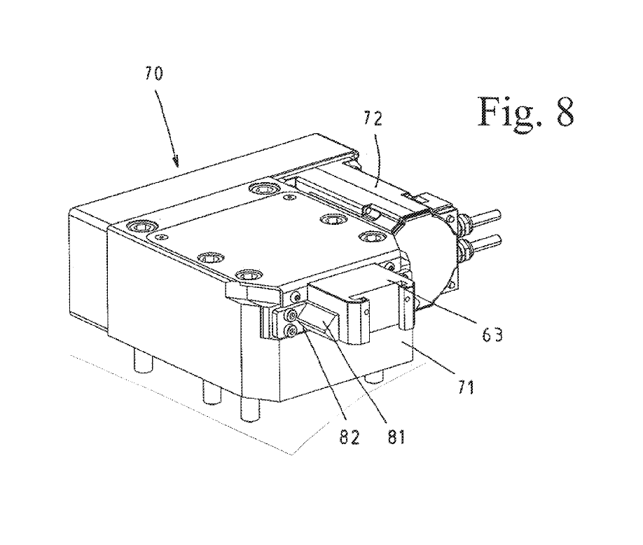

FIG. 8 is a perspective view of the press device according to FIG. 7.

A feed housing 10 of a power press according to FIG. 1 and FIG. 2 consists of a base plate 15, guide blocks 17, 18 and of four stamps 11 provided for a transverse press and which can be inserted radially into sliding tracks 13, 14 of the guide blocks 17, 18 with their lateral guide elements 11′, and in the centre form part of a matrix with the hollow chamber for the production of a pressed article, and for this purpose corresponding recesses 12 are formed on the front side of the stamps 11 as a negative mould for the pressed article. On the rear side the stamps 11 are each provided with a T-shaped coupling part 16 which can be coupled to a connector piece of a press device 49 according to FIG. 5.

In addition, a stamp that can be engaged from above and a stamp that can be engaged from below are provided on the press, but these are not detailed. On its lower side the base plate 15 has centring pins 15′ and can be appropriately centred on a press structure and be fixed by screws 19.

With this type of powder press pressed articles in particular are produced in the conventional manner In this connection the power is delivered into the matrix located in the centre on a plate element 29 that projects away laterally on the feed housing 10. After pressing the pressed articles are, for example, sintered, and used as cutting plates for tools.

According to the invention positioning means are respectively formed from a wedge arrangement 20 with a stop surface 22 placed crosswise to the moving direction of the stamp 11, this stop surface 22 serving directly as a stop for the stamp 11, as illustrated by FIG. 2.

The respective wedge arrangement 20 comprises a wedge 21 that can be adjusted crosswise to the moving direction of the stamp 11 and which has the stop surface 22 in the form of a wedge surface which can be brought into contact with a stop surface 11″ of the stamp 11, as shown on the stamp 11 at the top right of FIG. 1. The wedge 21 is guided here in the base plate 15 and its wedge surface is at an angle of several angular degrees in relation to its longitudinal extension so that this wedge arrangement 20 is within the self-inhibiting range upon pressing the stamp 11. Lying opposite the wedge surface or the stop surface 22 there is provided a guide surface 23 of the wedge 21 resting against an outer surface 24 of the base plate 15, which guide surface runs at right angles to its direction of adjustment.

This wedge arrangement 20 is also characterised in that these outer surfaces 24 of the base plate 15 do not run at right angles in relation to the radially moveable stamps 11, but at the same angle as the wedges. This results in the additional advantage that the stop surfaces 22 of the wedges 21, and so the stop surfaces 11″ of the stamp 11 run at right angles to the direction of adjustment of the stamps 11, and so transverse forces are prevented from acting on the stamp or on the base plate 15 in the pressing position, and only these forces acting on the pressed article in the moving direction are transmitted.

Advantageously, an adjusting means 25, 26 connected to the respective wedge arrangement 20 is provided for determining the pressing position of the respective stamp 11, which adjusting means may be a micrometer screw, a fine-adjustment screw or the like. Two adjusting means 25, 26 are respectively integrated into a guide block 17 parallel to the longitudinal axis of the feed housing 10. The other two guide blocks 18 are, however, made without these means. With this vertical arrangement of the adjusting means 25, 26 the latter can easily be operated manually from the upper side of the feed housing 10. A compression spring (not detailed) causes the wedge 21 to press constantly against the adjusting means.

FIG. 3 shows an adjusting means 26 in section, and the interaction of the latter with the corresponding wedge 21. This adjusting means 26 comprises an operable screw 26′ and a sliding nut 27 that can be height-adjusted by the latter in the guide block 17 and having an inclined surface 26′. The latter is in sliding contact with an inclined narrow side 21′ of the wedge 21. Upon adjusting the screw 26′ the wedge 21 is moved at right angles to the screw in its longitudinal extension, and so the pressing position of the stamp 11 is determined.

A feed housing 40 according to FIG. 4 is in itself configured in the same way as that according to FIG. 1 and FIG. 2. Therefore, in the following only the differences will be described in detail. In particular, the adjusting means 45, 46 for determining the pressing position are not arranged vertically, but more or less radially outwards within the feed housing 15. Their screws 45′, 46′ are respectively positioned with their front surface against an inclined narrow side 41 of the wedge 21 and bring about movement of the wedge in its longitudinal direction when turned, the wedge lying opposite being acted upon by a compression spring so that it constantly rests against the screw 45′, 46′.

From a certain size of the feed housing 10 these adjusting means 45, 46 could also be arranged more or less tangentially instead of more or less radially, and thereby be aligned in the longitudinal extension of the wedges 21. The advantage of this would be that 1:1 transmission would be brought about by adjusting the screws 45′, 46′, and no translation would have to be taken into account.

FIG. 5 shows a press device 49 which is conventional in itself, and which is not displayed in full detail. With the latter, by means of a hydraulic drive that is indicated, and by means of a wedge system connected to the latter within a housing 57, a connector piece 58, and consequently a stamp 11 that can be coupled to the latter within the feed housing 10, can be operated with a pre-defined contact pressure.

According to the invention, in this press device 49 a positioning means is respectively formed from a wedge arrangement 50 with a stop surface 53 placed crosswise to the moving direction of the connector piece 58 or of the stamp 11, this stop surface 53 serving as a stop for the extension piece 58 and so for the stamp 11.

This wedge arrangement 50 comprises a wedge 51 with the stop surface 53 as a wedge surface which rests against an inclined surface 54 formed on the connector piece 58. An adjusting means 55 connected to the wedge 51 can be operated by a screw 56 such that the wedge 51 can be moved along its sliding surface 52, and so in turn the pressing position of the stamp can be adjusted. A micrometer screw which enables positioning of the stamp in the micrometer range is used here as the adjusting means 55.

FIG. 6 shows a powder press 60 with the feed housing 10 according to the invention for four stamps and press devices assigned to the latter, of which only one stamp 11, however, and one press device 70, lying on the outside and coupled to the latter, is illustrated. These press devices are mounted here on a round base plate 61 that is indicated. A conveyor element projecting away to the side (not detailed) is provided by means of which the powder can be delivered to the hollow chamber of a matrix located in the centre.

Due to the compact design of these press devices 70, depending on the matrix from two to six of these could be arranged around a feed housing provided with a similar size to that according to FIG. 6.

This stamp 11 is coupled to a connector piece 63 of the press device 70 on the rear side turned away from the matrix by this T-shaped coupling part 16, delimiting the hollow chamber at the front. In addition, on the front side the stamp 11 is angled on both sides by an angle of 45° so that, as shown, in the pressing position the hollow chamber is completely enclosed. Depending on the number of stamps and the geometric form of the pressed article this angle can be appropriately adapted so that it is guaranteed that the stamps are extensively in contact with one another at the front.

The stamps 11 are pressed by the respective press device 70 against a stop surface according to the invention in the feed housing 10 so that during the entire pressing process the dimensions of this hollow chamber remain very precisely within the accuracy range of preferably one micrometer.

The four preferably identically formed press devices 70 are arranged at 90° relative to one another on the outside of the feed housing 10 according to the alignment of the stamps 11. They each consist of a linear drive 75, a housing 71 surrounding the latter, a connector piece 63 respectively coupled to a stamp 11, and of an electric motor 72 with cable connections 73 serving as a drive unit of the press.

FIG. 7 shows a section through the press device 70 shown on the left-hand side in FIG. 6. According to the invention a planetary roller screw drive or a roller screw drive which is provided with a centric threaded spindle 76 and with a plurality of planetary rollers 78 rotatably mounted in the latter by means of receiving bodies provided on a spindle nut is used for the linear drive 75 of the respective press device 70. The threaded spindle 76 held rotatably in rolling bearings 79 in the housing 71 is rotatably connected to the electric motor 72 by a transmission means 77, whereas the spindle nut is fastened to the connector piece 63 that can be moved in the axial direction of the threaded spindle 76. Such planetary roller screw drives or roller screw drives are known in their own right. Therefore, not all of the details of the transmission structure are displayed.

Upon engaging and pressing the stamps 11 in the operating state, the connector piece 63 respectively coupled to the latter is moved together with the spindle nut and the planetary rollers 78 by the rotating threaded spindle 76 in the pressing direction of the stamp 11.

As a further advantage of this press device 70 provision is made such that an offset 84 is provided between the axis 76′ of the threaded spindle 76 or of the spindle nut surrounding the latter concentrically and the axis of movement 83 of the connector piece 63 coupled to the latter.

FIG. 8 also illustrates the longitudinal guidance of the connector piece 63 within the housing 71 with which a guide carriage 81 connected to the spindle nut can be moved in guide tracks 82 within the housing 71. By means of said offset 84 of the movement axis of the connector piece 63 relative to the axis of the spindle nut, the width of this guide carriage 81 for the connector piece between the guide tracks 81 can be kept narrower and shorter than when the latter is located at the axial height of the spindle nut.

Within the framework of the invention these press devices 70 could each be equipped with a wedge arrangement in the same way as the one shown in FIG. 5.

The invention is sufficiently displayed by the above exemplary embodiments. However, it could also be realised by other variants. Thus, in the wedge arrangement two wedges 21 that can be adjusted relative to one another could also be provided. Thus, the stop surfaces 24 of the base plate 15 corresponding to the latter could be arranged at right angles.

In theory this wedge arrangement could be placed not below, but to the side of the stamp, and it could also be adjusted without an adjusting means in just one specific position if, for example, the same pressed articles are always produced.

The invention is of course also suitable when using just one stamp, which may be necessary depending on the requirement for the pressed article.

In principle, for the press device 70, instead of the described planetary roller screw drive or roller screw drive, an equivalent other gearing mechanism could be provided as the linear drive, by means of which high energy density can be generated with a small amount of space. In addition, two such linear drives could also be arranged next to one another for the pressing of a stamp.

The wedges are preferably each at an angle of a few angular degrees so that upon pressing the stamp this wedge arrangement is within the self-inhibiting range. Depending on the requirement the wedges could also be formed with a larger angle of inclination in the non-self-inhibiting range.

1. A powder press having preferably a plurality of stamps (11) which are movable for a transverse press in a feed housing (10), which stamps partially delimit a hollow chamber of a matrix in the feed housing (10), an adjustable positioning means being allocated to the respective stamp (11) for determining its pressing position, and being able to be coupled to a press device (49, 70) by a connector piece, characterised in that the respective positioning means is formed from a wedge arrangement (20, 50) having a stop surface (22, 53) and placed crosswise to the moving direction (V) of the stamp (11), this stop surface (22, 53) serving directly as a stop for the stamp (11) or as a stop for the connector piece (58) coupled to the latter.

2. The powder press according to claim 1, characterised in that the wedge arrangement (20, 50) comprises at least one wedge (21, 51) having the stop surface (22, 53) and which can be adjusted crosswise to the moving direction of the stamp (11), which wedge can be brought into contact with a stop surface (11″ or 54) on the stamp or on the connector piece, the wedge surface of the wedge (21, 51) being at an angle of a few angular degrees in relation to its longitudinal extension so that this wedge arrangement is in the self-inhibiting range in the pressing direction.

3. The powder press according to claim 1, wherein the surfaces (24) of the base plate (15) that are in sliding contact with the wedges (21) are respectively not at right angles to the radial moving directions (V) of the stamps (11) but, in contrast, are formed at the same angle as the wedges so that the stop surfaces (22) of the wedges (21) or the stop surfaces (11″) of the stamps (11) respectively run at right angles to their moving direction (V).

4. The powder press according to claim 1, further comprising adjusting means (25, 26, 45, 46, 55) connected to the respective wedge arrangement (20, 40, 50) is provided for determining the pressing position of the respective stamp (1), which adjusting means is a micrometer screw, a fine-adjustment screw or the like.

5. The powder press according to claim 4, characterised in that these adjusting means (25, 26, 45, 46, 55) are respectively aligned either vertically, more or less radially and/or more or less tangentially to the moving direction (V) of the stamp (11).

6. The powder press according to claim 4, wherein the adjusting means (25, 26, 45, 46, 55) are arranged such that they can be operated manually from the outside.

7. The powder press according to claim 4, wherein the respective wedge arrangement (50) and the adjusting means (55) is placed on the connector piece (58) that can be coupled to the respective stamp in the press device (49).

8. A feed housing for a powder press according to claim 1, wherein a plurality of stamps (11) are provided for the transverse press, which stamps are collectively mounted such that they can be moved more or less radially within the feed housing (10) and in the centre form part of a matrix with the hollow chamber for producing a pressed article, characterised in that there is assigned to each stamp (11) a positioning means mounted within the feed housing (10), which positioning means is respectively formed by a wedge arrangement (20) having a stop surface (22) and placed crosswise to the moving direction (V) of the stamp (11), which stop surface serves directly as a stop for the stamp.

9. The feed housing according to claim 8, characterised in that an adjusting means (25, 26) connected to the respective wedge arrangement (20) is provided for determining the pressing position of the respective stamp (11), said adjusting means being a micrometer screw, a fine-adjustment screw or the like.

10. A stamp for a feed housing, in particular for a powder press, according to claim 8, which stamp forms guide elements (11′) for a movable mounting within the feed housing (10) and at the front forms a recess (12) for a hollow chamber for the production of a pressed article, wherein there is assigned to the stamp (11) a stop surface (11″) as a stop for a positioning means within the feed housing (10) by means of which a pressing position is made possible for the latter.

11. The stamp according to claim 10, characterised in that this stop surface (11″) is aligned crosswise to the guide elements (11′).

12. A press device for a powder press, preferably according to claim 1, having at least one linear drive (75) for adjusting a connector piece (63) that can be coupled to a stamp (11) of a matrix, and a drive unit rotatably connected to the respective linear drive (75), wherein there is provided for the respective linear drive (75) a planetary roller screw drive, a roller screw drive or a gear mechanism that works in the same way, which is provided with a rotatably mounted threaded spindle (76), a spindle nut securely connected to the connector piece (63) and with a plurality of planetary rollers or screw rollers (76) rotatably mounted in the latter, the spindle nut, and with it the connector piece (63), being movable in the pressing direction of the stamp (11) upon rotating the threaded spindle (76).

13. The press device according to claim 12, characterised in that a housing (71) that can be fastened to the base plate (61) of the powder press and having the linear drive (75) integrated in it is provided.

14. The press device according to claim 12, wherein there is an offset (84) between the axis (76′) of the threaded spindle (76) and the spindle nut that surrounds the latter concentrically and the axis of movement (83) of a guide carriage (81) coupled to the latter or of the connector piece (63).

15. The powder press according to claim 2, wherein the surfaces of the base plate that are in sliding contact with the wedges are respectively not at right angles to the radial moving directions of the stamps but, in contrast, are formed at the same angle as the wedges so that the stop surfaces of the wedges or the stop surfaces of the stamps respectively run at right angles to their moving direction.

16. The powder press according to claim 2, further comprising an adjusting means connected to the respective wedge arrangement is provided for determining the pressing position of the respective stamp, which adjusting means is a micrometer screw, a fine-adjustment screw or the like.

17. The powder press according to claim 16, wherein the adjusting means are respectively aligned either vertically, more or less radially and/or more or less tangentially to the moving direction of the stamp.

18. The powder press according to claim 5, wherein the adjusting means are arranged such that they can be operated manually from the outside.

19. The powder press according to claim 5, wherein the respective wedge arrangement and the adjusting means is placed on the connector piece that can be coupled to the respective stamp in the press device.

20. A stamp for a feed housing according to claim 9, which stamp forms guide elements for a movable mounting within the feed housing and at the front forms a recess for a hollow chamber for the production of a pressed article, wherein there is assigned to the stamp a stop surface as a stop for a positioning means within the feed housing by means of which a pressing position is made possible for the latter.
